(19) United States
(12) Patent Application Publication
(10) Pub. No.: US 2014/0340979 A1
(43) Pub. Date: Nov. 20, 2014

(54) Agitator, System, and Method for Using the Same

(71) Applicant: Hubert Richard Keel, III, Denver, CO (US)

(72) Inventor: Hubert Richard Keel, III, Denver, CO (US)

(21) Appl. No.: 14/271,377

(22) Filed: May 6, 2014

Related U.S. Application Data
(60) Provisional application No. 61/820,153, filed on May 6, 2013.

(51) Int. Cl. A47J 43/27

(52) U.S. Cl. CPC A47J 43/27
USPC 366/130; 366/343

(57) ABSTRACT

Provided herein is an agitator, comprising a body having a central axis and an asymmetric weight distribution; and a plurality of spines, each spine having a shaft and a termination, wherein the shaft smoothly transitions from the body; wherein the body and spines are adapted to enhance mixing when the agitator is shaken in a vessel containing a powder and a liquid medium.

### CROSS-REFERENCE

This application claims the benefit under 35 U.S.C. §119(e) of U.S. provisional application 61/820,153, filed May 6, 2013, and entitled “Agitator, System, and Method for Using the Same,” the disclosure of which is incorporated by reference in its entirety.

### TECHNICAL FIELD

The present disclosure relates to devices and methods related to dissolving or suspending solids into liquids. In particular, the present invention relates to an agitator, which facilitates dissolution of protein and fiber powders into an aqueous medium, systems comprising such agitators, and methods for using the same.

### BACKGROUND

Protein, fiber, and other nutritional supplements are typically sold as bulk powders. Before consumption, these powders must be dissolved in water or another aqueous medium, forming a solution or suspension suitable for drinking. The problem is that these powders cake and aggregate in the mixing vessel. Improper mixing leads to several disadvantages, including reduced nutritional value, inaccurate dosing, undesirable texture in the beverage, user frustration, and increased cleaning time of the vessel used for mixing.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present disclosure provides an agitator, which advantageously mixes protein powders and other nutritional supplements into a liquid medium, such as an aqueous medium. The agitator comprises a body having a central axis and an asymmetric weight distribution, and a plurality of spines distributed on the body of the agitator. The shaft of each spine smoothly extends from the body without forming a hard angle or crevice between the body and the spine. Likewise, the termination of the spine smoothly thickens in relation to the shaft. The body may further comprise a knob or process, which is useful for smashing aggregated powder, thus aiding its dissolution or suspension into the liquid medium.

The spines are distributed such that, when shaken in a closed vessel with the powder and liquid medium, the agitator provides a chaotic, near-chaotic, or stochastic mixing motion. In some embodiments, the terminations of the spines form a locus of points describing a sphere, thus providing the desired mixing motion when shaken. A vortex may also be formed behind the forward progression of the agitator through the liquid medium. This mixing motion quickly and thoroughly distributes the powder into the medium, forming a homogeneous solution or suspension.

Also provided is a system comprising an agitator and a vessel with an inner surface shaped so that the powder does not aggregate or cake during mixing, for example by providing an inner surface that is substantially free of any hard angle or crevice where powder can aggregate. The inner surface also promotes the stochastic and vortex-forming mixing motion provided by the agitator when shaken. The bottom of the vessel cavity is hemispherical. With a hemispherical shape, multiple spines of the agitator contact the inner surface of the vessel regardless of the orientation of the agitator at rest.

The system may further comprise a cap. The inner surface of the underside of the lid may be concave and hemispherical, either with the same hemispherical radius as the bottom interior of the vessel or a hemisphere with a different aspect ratio. When the cap is attached to the vessel, the inner cavity formed by the inner surface of the vessel and the inner surface of the cap forms a continuous surface substantially free of cracks, crevices, and sharp angles.

The cap optionally further comprises an opening for receiving a lid. The lid comprises a plug and a fastener. The plug removably closes the opening in the cap so that a user may access the contents of the vessel without removing the cap from the vessel. The lid seals the opening in the cap such that the inner surface of the cap fully communicates with the underside of the lid. As such, the hemispherical shape of the inner surface of the cap is not disrupted by the presence of the cap. The fastener lid may be attached to the cap by any method known to one of skill in the art, for example by a receptacle on the cap to receive the fastener on the lid.

In further embodiments, there is provided a method for using a system comprising an agitator. In still further embodiments, there is also provided a method for making the agitator.

The agitator may also be scaled such that it may be used in vessels of varying sizes. For example, an agitator may be used in a vial to aid dissolution of a medicament into a pharmaceutically acceptable carrier. An agitator may also be scaled so that it may aid the dissolution of dry buffer media into a multi-liter shaker bottle. The advantages provided by the agitator are similar on any scale, namely the nutritional or medical value of the solid is enhanced, concentration and dosages are more accurate dosing, beverages maintain a desirable texture, users avoid undue frustration, and cleaning time is reduced for the vessel used for mixing.

Additional embodiments and features are set forth in part in the description that follows, and in part will become apparent to those skilled in the art upon examination of the specification, or may be learned by the practice of the embodiments discussed herein. A further understanding of the nature and advantages of certain embodiments may be realized by reference to the remaining portions of the specification and the drawings, which forms a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the scope of the disclosure.

FIG. 1 shows a first perspective view of a first embodiment of the agitator. The agitator comprises an egg-shaped body having a central axis and seventeen spines: one spine located at the apex of the narrow part of the body aligned with the central axis, and three sets of four spines, the set being radially distributed about the central axis in the shape of a square. Each set is offset by about 22° from neighboring set down the central axis. The apical spine is shorter than the radial spines. Each spine terminates with a knob that is wider than the shaft of the spine. The terminations describe a locus of points on a sphere.

FIG. 2 shows a second perspective view of the agitator from FIG. 1.

FIG. 3 shows a third perspective view of the agitator from FIG. 1.

FIG. 4 shows a side elevational view of the agitator from FIG. 1.

FIG. 5 shows a bottom plan view of the agitator from FIG. 1, where the bottom is the perspective looking down the wide part of the egg-shaped body.

FIG. 6 shows a top plan view of the agitator from FIG. 1, where the top is the perspective looking down the narrow part of the egg-shaped body.

FIG. 7 shows a first perspective view of a second embodiment of the agitator. The agitator comprises a cylindrical body having a central axis, a top knob at a first end of the body, a bottom knob at a second end of the body, and nine spines. The spines are grouped into three sets of three, the sets being radially distributed about the central axis of the spine in the shape of a triangle. Each set is offset by about 40° from the neighboring set down the central axis.

FIG. 8 shows a second perspective view of the agitator from FIG. 7.

FIG. 9 shows a first side elevational view of the agitator from FIG. 7.

FIG. 10 shows a second side elevational view of the agitator from FIG. 7.

FIG. 11 shows a top plan view of the agitator from FIG. 7, where the top is the perspective looking down the top knob.

FIG. 12 shows a bottom plan view of the agitator from FIG. 7, where the bottom is the perspective looking down the bottom knob.

FIG. 13 shows a first perspective view of a third embodiment of the agitator. The agitator comprises an egg-shaped body having a central axis and eight spines in two sets of four spines, the set being radially distributed about the central axis in the shape of a square. Each set is offset by about 45° from neighboring set down the central axis. Each spine terminates with a knob that is wider than the shaft of the spine. The terminations describe a locus of points on a sphere.

FIG. 14 shows a second perspective view of the agitator from FIG. 13.

FIG. 15 shows a side elevational view of the agitator from FIG. 13.

FIG. 16 shows a top plan view of the agitator from FIG. 13.

FIG. 17 shows a bottom plan view of the agitator from FIG. 13.

FIG. 18 shows a first perspective view of a fourth embodiment of the agitator. The agitator comprises a spherical body having a central axis and eight, the spines being radially and asymmetrically distributed about the central axis. Each spine terminates with a knob that is wider than the shaft of the spine. The terminations describe a locus of points on a sphere.

FIG. 19 shows a second perspective view of the agitator from FIG. 18.

FIG. 20 shows a third perspective view of the agitator from FIG. 18.

FIG. 21 shows a fourth perspective view of the agitator from FIG. 18.

FIG. 22 shows a fifth perspective view of the agitator from FIG. 18.

FIG. 23 shows a sixth perspective view of the agitator from FIG. 18.

FIG. 24 shows an exploded first perspective view of a system for use with the agitator, comprising a vessel, lid, and cap.

FIG. 25 shows an exploded second perspective view of the system depicted in FIG. 24.

FIG. 26 shows an exploded side view of the system depicted in FIG. 24.

FIG. 27 shows an exploded front view of the system depicted in FIG. 24.

FIG. 28 shows a top plan view of the system depicted in FIG. 24.

FIG. 29 shows a bottom plan view of the system depicted in FIG. 24.

FIG. 30 shows a first perspective view an embodiment of the vessel from a system for use with the agitator.

FIG. 31 shows a second perspective view of the vessel from FIG. 30.

FIG. 32 shows a front elevational view of the vessel from FIG. 30.

FIG. 33 shows a top plan view of the vessel from FIG. 30.

FIG. 34 shows a bottom plan view of the vessel from FIG. 30.

FIG. 35 shows a first perspective view an embodiment of the lid from a system for use with the agitator.

FIG. 36 shows a second perspective view of the lid from FIG. 35.

FIG. 37 shows a third perspective view of the lid from FIG. 35.

FIG. 38 shows a fourth perspective view of the lid from FIG. 35.

FIG. 39 shows a side elevational view of the lid from FIG. 35.

FIG. 40 shows a front elevational view of the lid from FIG. 35.

FIG. 41 shows a bottom plan view of the lid from FIG. 35.

FIG. 42 shows a top plan view of the lid from FIG. 35.

FIG. 43 shows a first perspective view an embodiment of the cap from a system for use with the agitator.

FIG. 44 shows a second perspective view of the cap from FIG. 43.

FIG. 45 shows a third perspective view of the cap from FIG. 43.

FIG. 46 shows a side elevational view of the cap from FIG. 43.

### DETAILED DESCRIPTION

The present disclosure may be understood by reference to the following detailed description, taken in conjunction with the drawings as described above. It is noted that, for purposes of illustrative clarity, certain elements in various drawings may not be drawn to scale, may be represented schematically or conceptually, or otherwise may not correspond exactly to certain physical configurations of embodiments.

The body of the agitator may be any three-dimensional solid with an uneven or asymmetrical weight distribution. For example, the body may be egg-shaped, ovoid, oviform, spherical, cylindrical, cubic, trapezoidal, tetrahedral, pyramidal, icosahedral, or dodecahedral.

The agitator comprises a plurality of spines radially distributed on the body about the central axis of the body. The spines may be singular, such as an apical spine aligned with the central axis, or may be grouped in sets, for example, in sets of two, of three, of four, of five, of six, of seven, or of eight. Within each set, the spines are arranged so that they are as far apart from each other and in the same planar cross-section. For example, a set of two is arranged along a straight line with an angle θ of 180° between the two spines. A set of three is triangularly arranged, or arranged in the shape of a triangle with an angle θ of about 120°. A set of four is squarely arranged, or arranged in the shape of a square with an angle θ of about 90°. A set of five is pentagonally arranged, or arranged in the shape of pentagon with an angle θ of about 72°. A set of six is hexagonally arranged, or arranged in the shape of a hexagon with an angle θ of about 60°. A set of seven is heptagonally arranged, or arranged in the shape of a heptagon with an angle θ of about 51.5°. A set of eight is octagonally arranged, or arranged in the shape of an octagon with an angle θ of about 45°. The spines may consist of one or more sets, for example, of two sets, three sets, four sets, five sets, or six sets of spines.

The number of spines on the body of the agitator can and will vary. In some embodiments, the body may have 3 to 49 spines, such as 3 to 5 spines, 5 to 9 spines, 8 to 21 spines, 9 to 11 spines, 11 to 14 spines, 13 to 21 spines, 13 to 17 spines, 14 to 25 spines, 25 spines to 33 spines, or 33 to 49 spines. In other embodiments, the body may have 5 to 33 spines. In particular embodiments, the body may have 8 spines. In some embodiments, the body may have 9 spines. In other embodiments, the body may have 11 spines. In still other embodiments, the body may have 13 spines. In other embodiments, the body may have more than 3 spines, such as more than 5 spines, more than 8 spines, or more than 11 spines. In other embodiments, the body may have less than 49 spines, such as less than 33 spines, or less than 13 spines.

When the spines consist of more than one set, each set is offset from a neighboring set down the central axis. In some embodiments, the spines may consist of 2 sets, 3 sets, 4 sets, 5 sets, 6 sets, 7 sets, 8 sets, 9 sets, or 10 sets. Typically, the offset is related to the geometric distribution within the set. For example, a set of two with a linear distribution is offset from a neighboring set by an angle φ of about 45°. A set of three with a triangular distribution is offset from a neighboring set by an angle φ of about 30°. A set of four with a square distribution is offset from a neighboring set by an angle φ of about 22.5°. A set of five with a pentagonal distribution is offset from a neighboring set by an angle φ of about 18°. A set of six with a hexagonal distribution is offset from a neighboring set by an angle φ of about 15°. Generally, the offset between neighboring sets is by a quarter the number of degrees that adjacent spines within the same set.

The apical spine may be shorter than the radial spines. Each spine may terminate with a knob that is proportionally wider than the shaft of the spine. The knobby termination advantageously improves the mixing ability of the agitator and reduces the amount of powder caked on the agitator or the mixing vessel.

Referring to FIGS. 1-6, a first perspective view of a first embodiment of the agitator 100 is shown. The agitator 100 comprises an egg-shaped body 110 having a central axis 150 and seventeen spines 120,125: one spine 125 located at the apex of the narrow part 115 of the body 110 aligned with the central axis 150, and four sets a,b,c,d of four spines 120, the sets a,b,c,d being radially distributed about the central axis 150 in the shape of a square (angle θ of about 90°). Each set a,b,c,d is offset by an angle φ of about 22° from neighboring set a,b,c,d down the central axis 150. The apical spine 150 is shorter than the radial spines 120. Each spine 120,125 terminates with a knob 130 that is wider than the shaft 140 of the spine 120,125. The terminations (knobs 130) describe a locus of points on a sphere 170.

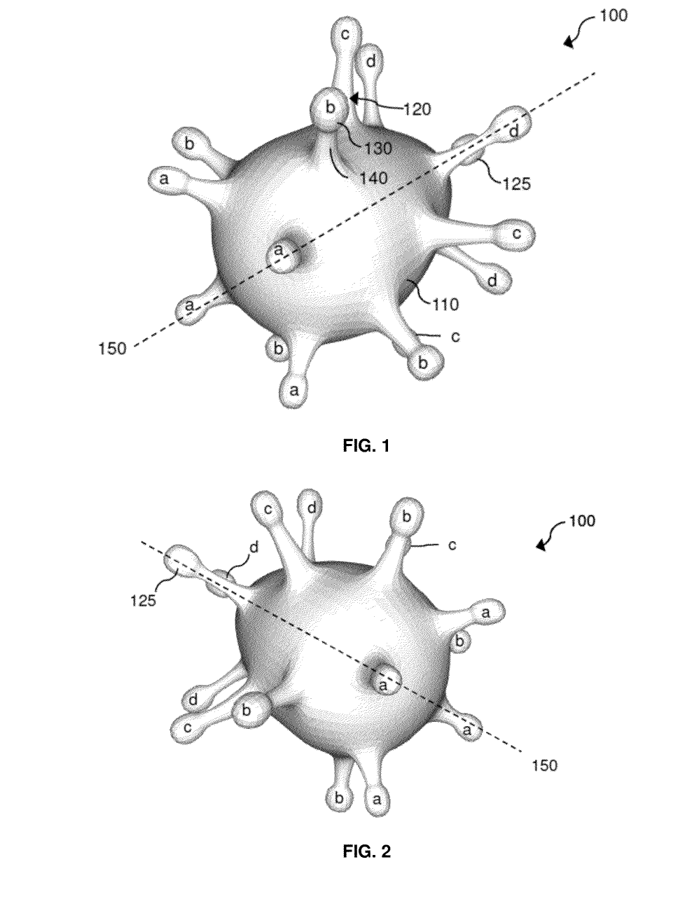

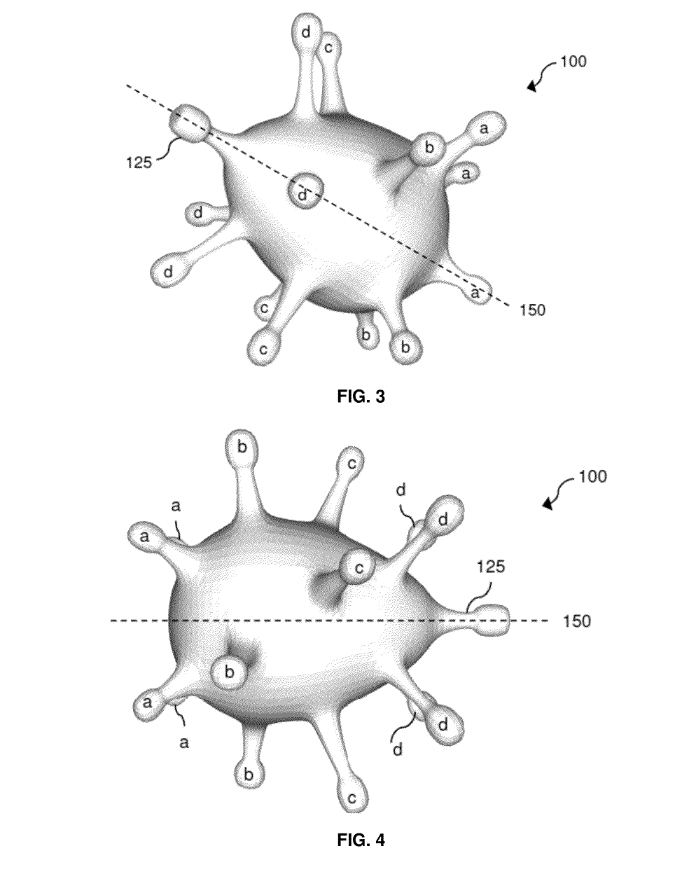

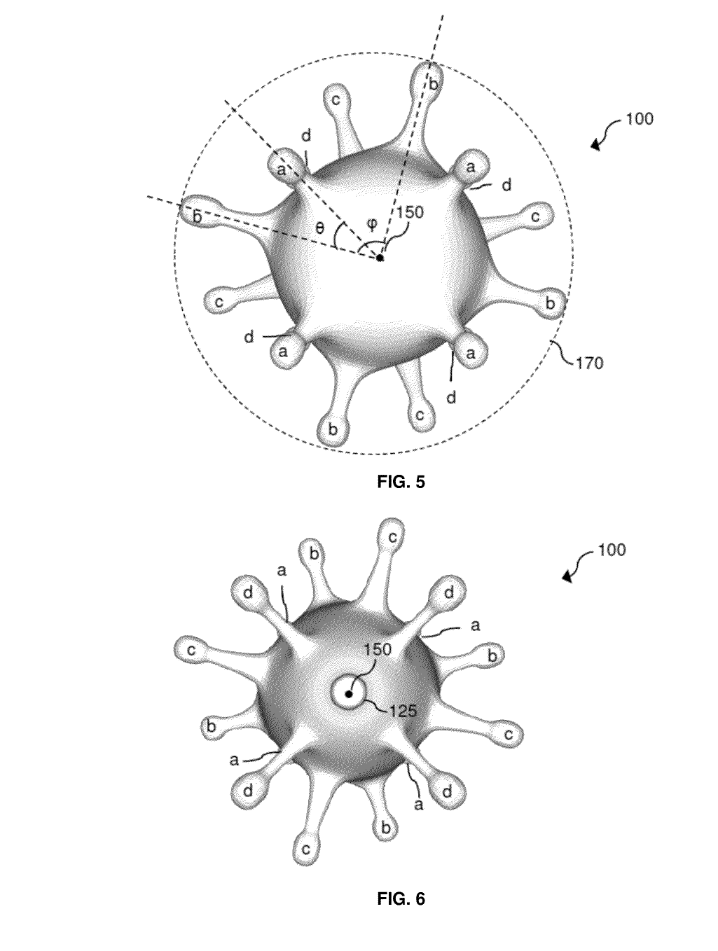

FIG. 2 shows a second perspective view of the agitator 100 from FIG. 1. FIG. 3 shows a third perspective view of the agitator 100 from FIG. 1. FIG. 4 shows a side elevational view of the agitator 100 from FIG. 1. FIG. 5 shows a bottom plan view of the agitator 100 from FIG. 1, where the bottom is the perspective looking down the wide part 127 of the egg-shaped body 110. FIG. 6 shows a top plan view of the agitator 100 from FIG. 1, where the top is the perspective looking down the narrow part 115 of the egg-shaped body 110.

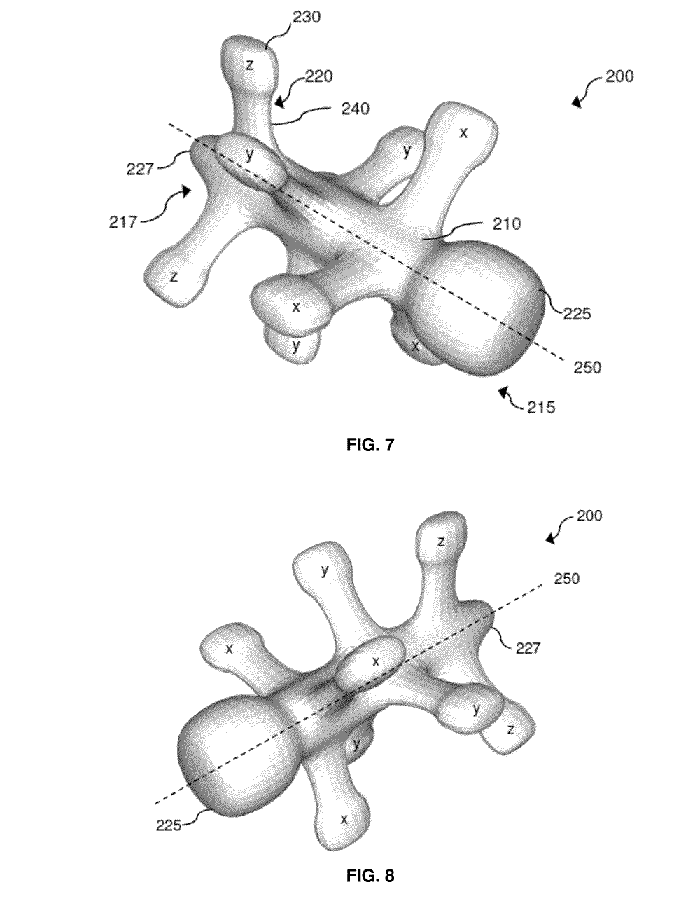

Referring to FIGS. 7-12, a first perspective view of a second embodiment of the agitator 200 is shown. The agitator 200 comprises a cylindrical body having a central axis 250, a top knob 225 at a first end of the body 215, a bottom knob 227 at a second end of the body 217, and nine spines 220. The spines 220 are grouped into three sets x,y,z of three, the sets x,y,z being radially distributed about the central axis 250 in the shape of a triangle (angle θ of about) 120°. Each set x,y,z is offset by an angle φ of about 40° from the neighboring set x,y,z down the central axis 250.

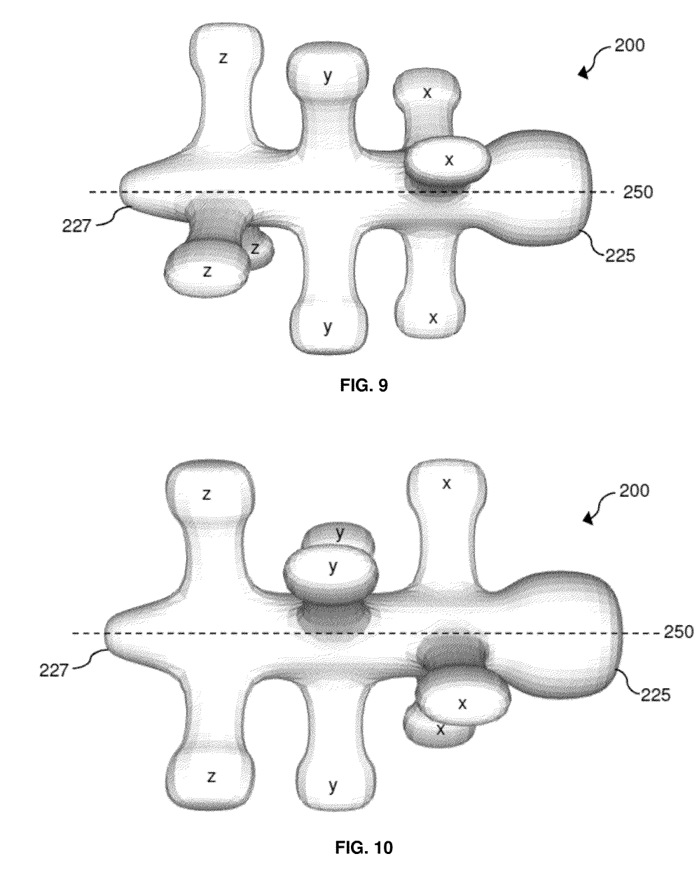

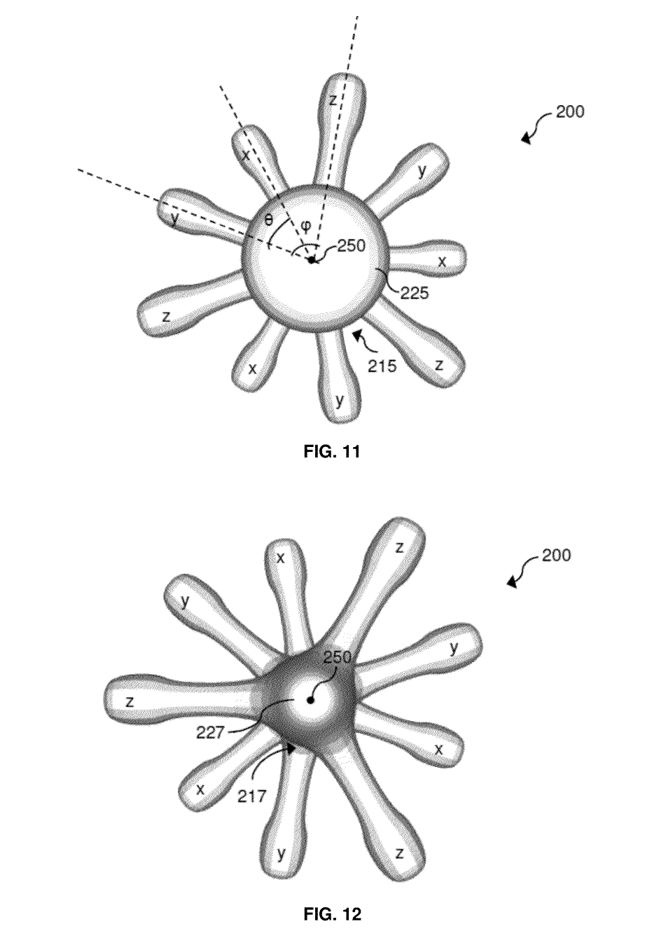

FIG. 8 shows a second perspective view of the agitator 200 from FIG. 7. FIG. 9 shows a first side elevational view of the agitator 200 from FIG. 7. FIG. 10 shows a second side elevational view of the agitator 200 from FIG. 7. FIG. 11 shows a top plan view of the agitator 200 from FIG. 7, where the top is the perspective looking down the top knob 225. FIG. 12 shows a bottom plan view of the agitator 200 from FIG. 7, where the bottom is the perspective looking down the bottom knob 227.

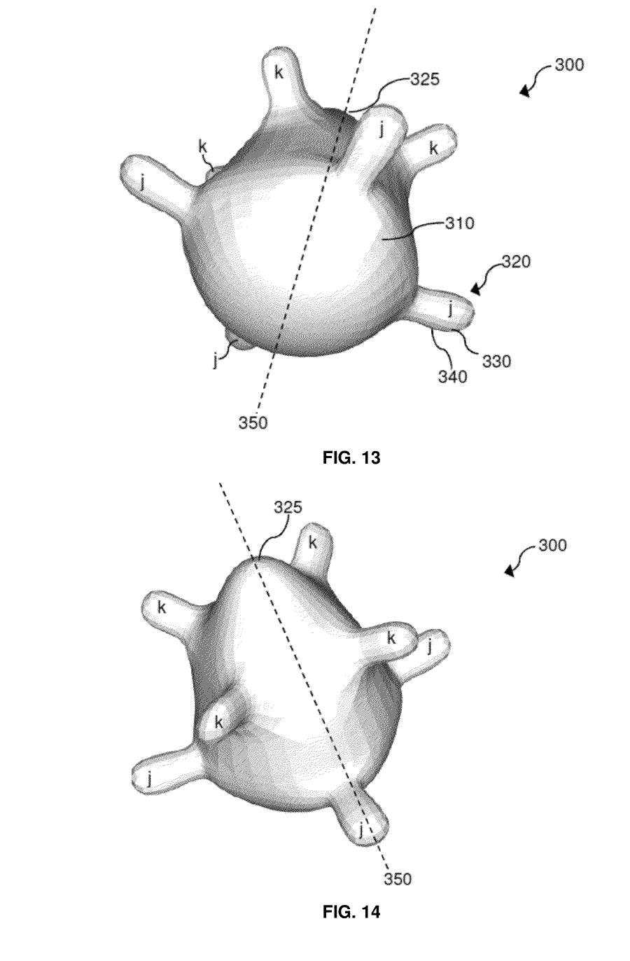

Referring to FIGS. 13-17, a first perspective view of a third embodiment of the agitator 300 is shown. The agitator 300 comprises an egg-shaped body 310 having a central axis 350 and eight spines 320 in two sets j,k of four spines 320, the sets j,k being radially distributed about the central axis 350 in the shape of a square (angle θ of about 90°). Each set j,k is offset by an angle φ of about 45° from neighboring set j,k down the central axis 350. Each spine 320 terminates with a knob 330 that is wider than the shaft 340 of the spine 320. The terminations (knobs 330) describe a locus of points on a sphere 370.

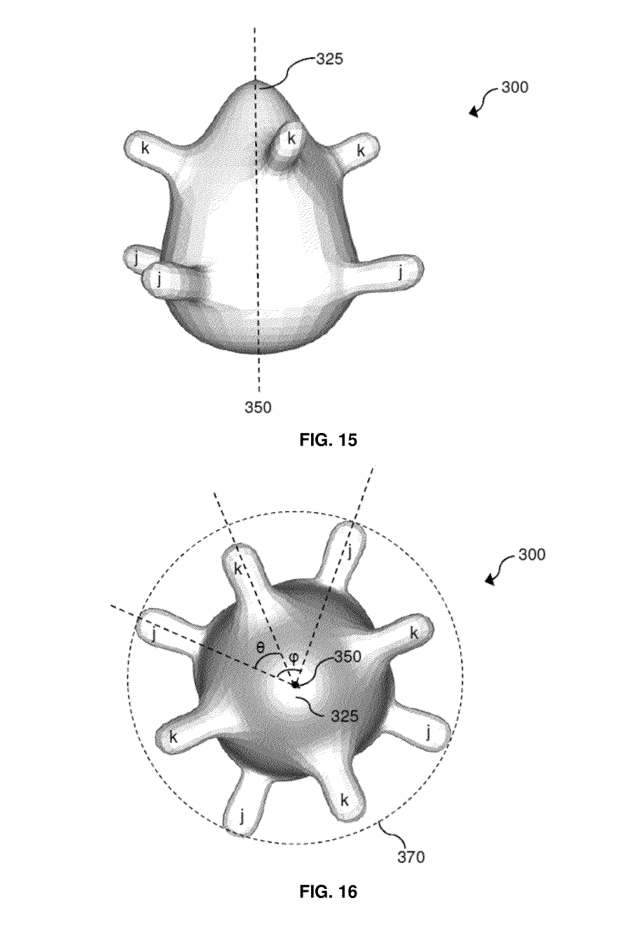

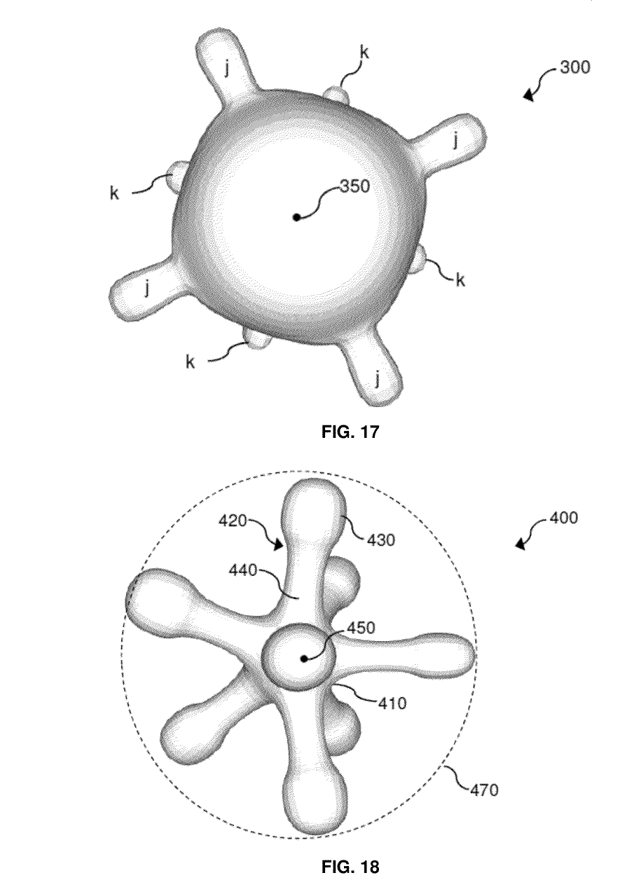

FIG. 14 shows a second perspective view of the agitator 300 from FIG. 13. FIG. 15 shows a side elevational view of the agitator 300 from FIG. 13. FIG. 16 shows a top plan view of the agitator 300 from FIG. 13. FIG. 17 shows a bottom plan view of the agitator 300 from FIG. 13.

Referring to FIGS. 18-22, a first perspective view of a fourth embodiment of the agitator 400 is shown. The agitator 400 comprises a spherical body 410 having a central axis 450 and eight spines 420, radially and asymmetrically distributed about the central axis 450. Each spine 420 terminates with a knob 430 that is wider than the shaft 440 of the spine 420. The terminations (knobs 430) describe a locus of points on a sphere 470.

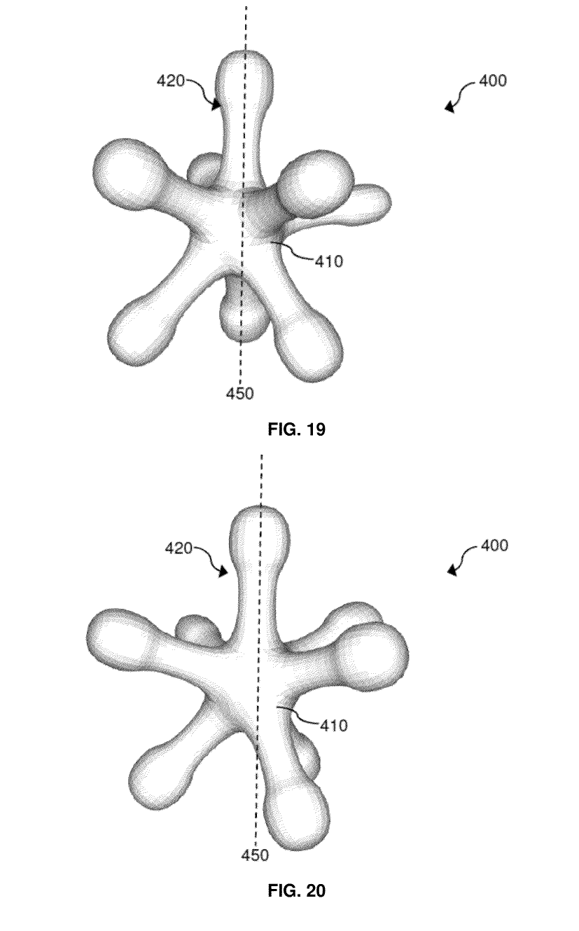

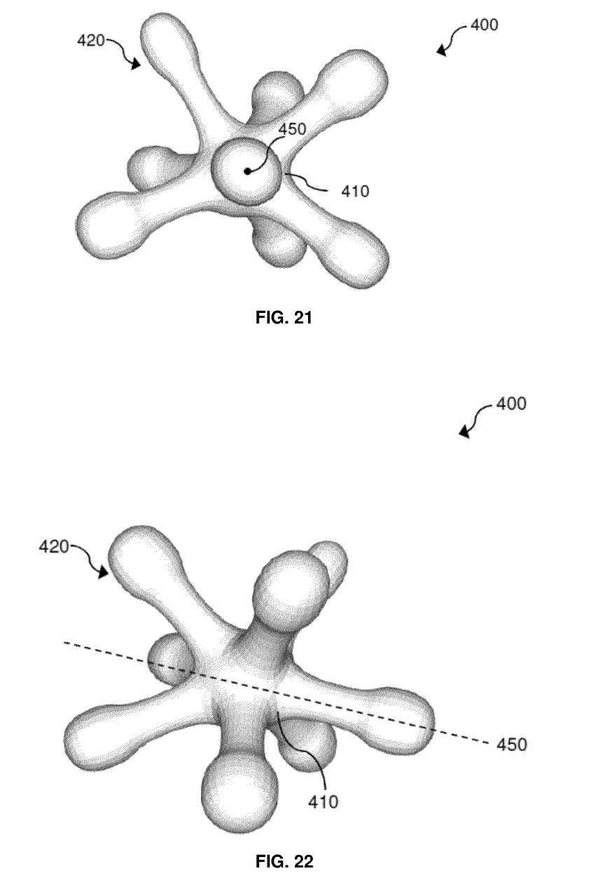

FIG. 19 shows a second perspective view of the agitator 400 from FIG. 18 FIG. 20 shows a third perspective view of the agitator 400 from FIG. 18. FIG. 21 shows a fourth perspective view of the agitator 400 from FIG. 18. FIG. 22 shows a fifth perspective view of the agitator 400 from FIG. 18. FIG. 23 shows a sixth perspective view of the agitator 400 from FIG. 18.

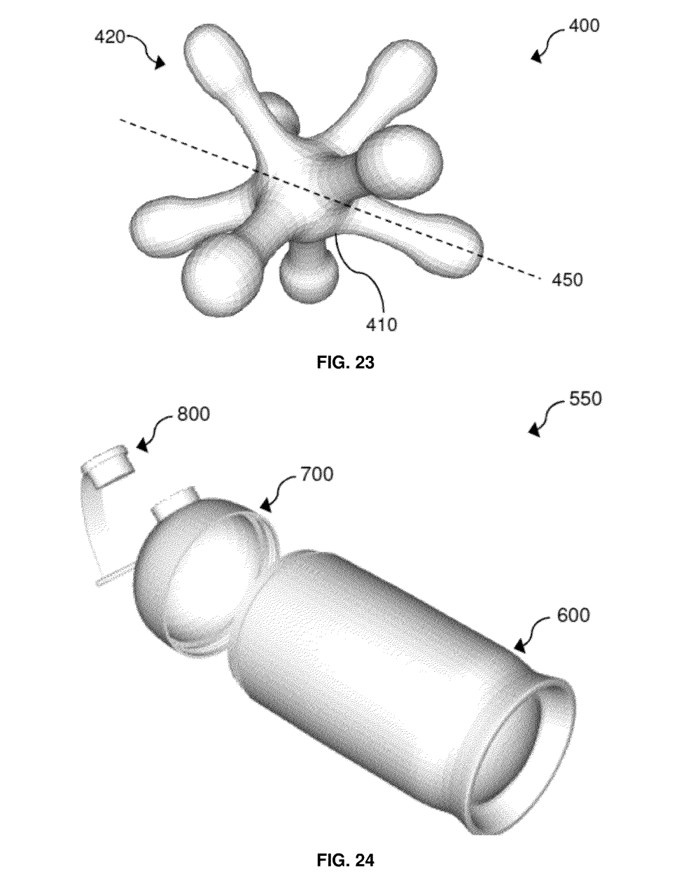

Referring to FIGS. 24-46, provided herein is a system 500 comprising an agitator (e.g., but not limited to, 100, 200, 300, or 400, or any embodiment described herein and variations thereof, or any agitator known in the art) and a vessel 600 with an inner surface 610 shaped so that the powder does not aggregate or cake during mixing, for example by providing an inner surface 610 that is substantially free of any hard angle or crevice where powder can aggregate. In other embodiments, the system 550 does not comprise an agitator, but is adapted for use with any agitator as described herein or as described in the art.

The inner surface 610 also promotes the stochastic and vortex-forming mixing motion provided by the agitator when shaken. In some embodiments, the bottom 620 of the vessel 600 cavity may be hemispherical. With a hemispherical shape, multiple spines of the agitator contact the inner surface of the vessel regardless of the orientation of the agitator at rest, especially in embodiments where the terminations of the spines of the agitator form a locus of points describing a sphere (e.g., 170, 370 or 470).

The system 550 may further comprise a lid 700 and cap 800. The inner surface 810 of the underside of the cap 800 may be concave and hemispherical, either with the same hemispherical radius as the bottom interior 620 of the vessel 600 or a hemisphere with a different aspect ratio. When the cap 800 is attached to the vessel 600, the inner cavity 510 formed by the inner surface 610 of the vessel 600 and the plug 810 of the cap 800 and the inner surface 710 of the lid 700 forms a continuous surface substantially free of cracks, crevices, and sharp angles. The plug 810 of the cap 800 is adapted to fit into an opening 720 of the lid 700. The opening 720 may have a rim 730. The outer surface 760 of the lid 700 may have a receptacle 740 for a latch 840 on the cap 800. The plug 810 of the cap 800 may be connected to the latch 840 by a strap 860 of variable length, selected so that when the cap 800 is disengaged from opening 720, the cap 800 remains attached to the lid 700 via strap 860 fastened by the latch 840 at the receptacle 740.

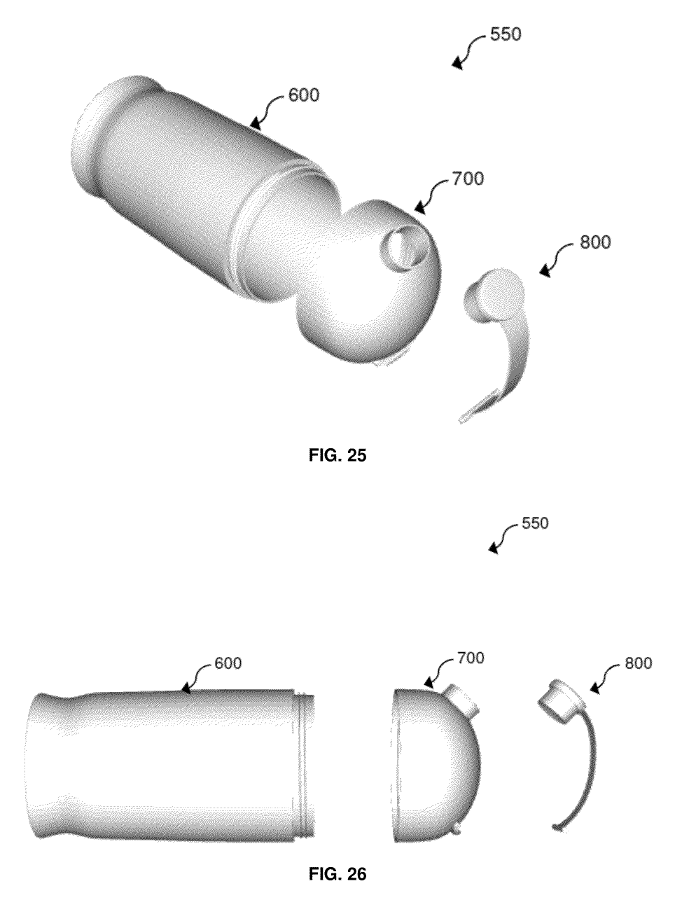

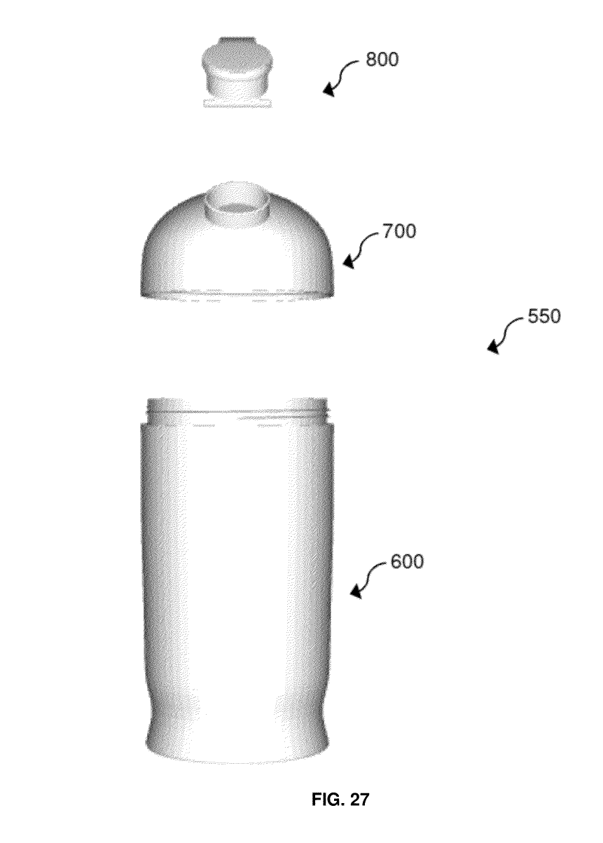

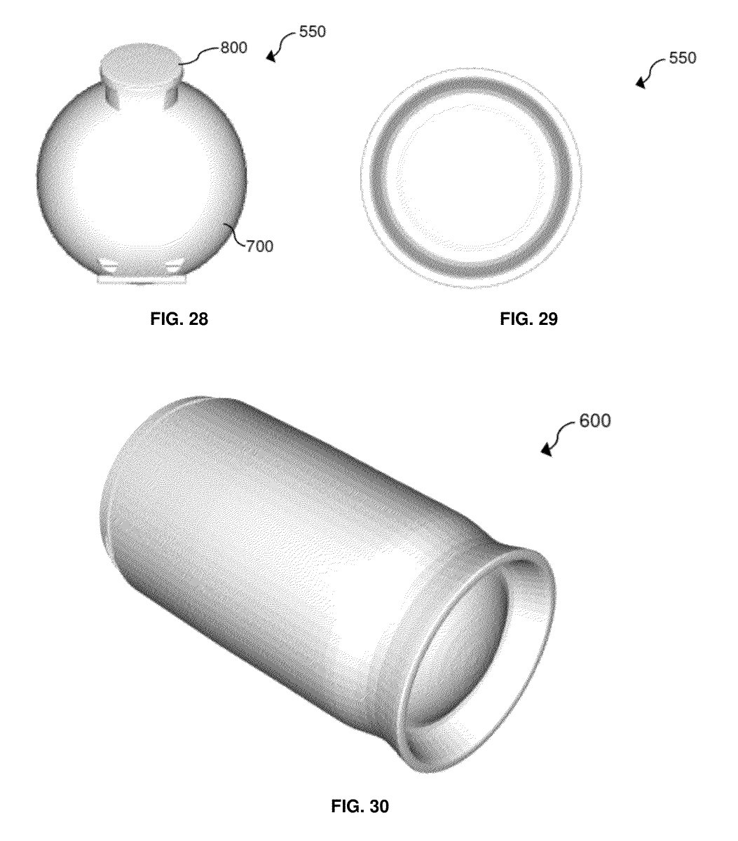

FIG. 24 shows an exploded first perspective view of a system 550 for use with the agitator, comprising a vessel 600, lid 700, and cap 800. FIG. 25 shows an exploded second perspective view of the system 550 depicted in FIG. 24. FIG. 26 shows an exploded side view of the system 550 depicted in FIG. 24. FIG. 27 shows an exploded front view of the system depicted in FIG. 24. FIG. 28 shows a top plan view of the system 550 depicted in FIG. 24. FIG. 29 shows a bottom plan view of the system 550 depicted in FIG. 24.

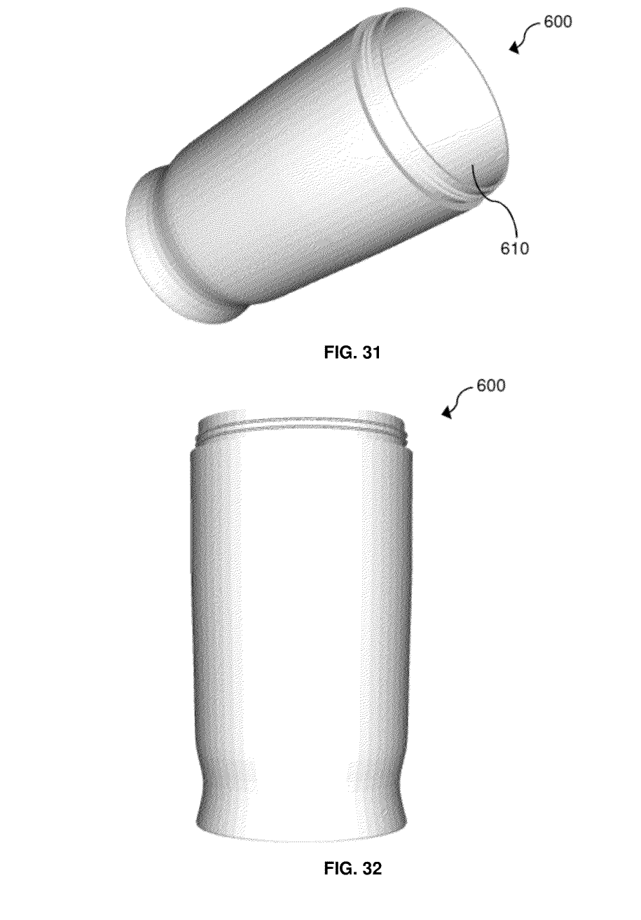

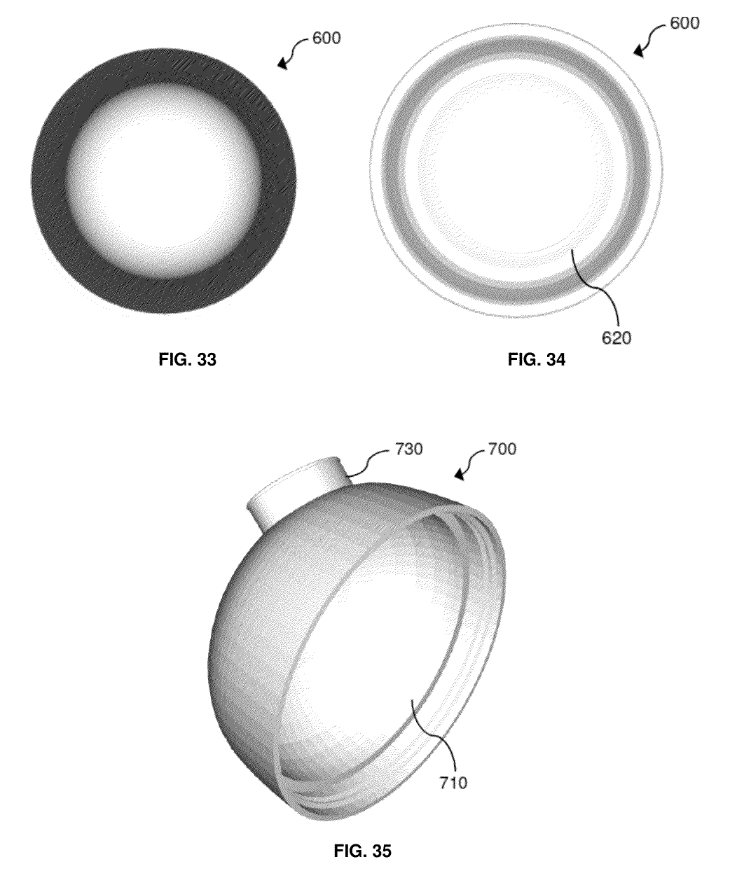

FIG. 30 shows a first perspective view an embodiment of the vessel 600 from a system for use with the agitator. FIG. 31 shows a second perspective view of the vessel 600 from FIG. 30. FIG. 32 shows a front elevational view of the vessel 600 from FIG. 30. FIG. 33 shows a top plan view of the vessel 600 from FIG. 30. FIG. 34 shows a bottom plan view of the vessel 600 from FIG. 30.

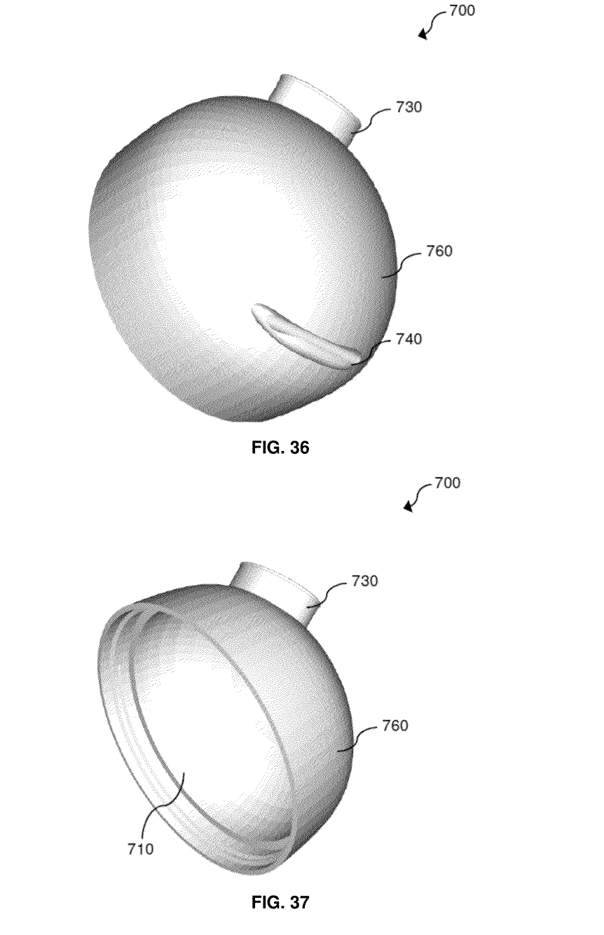

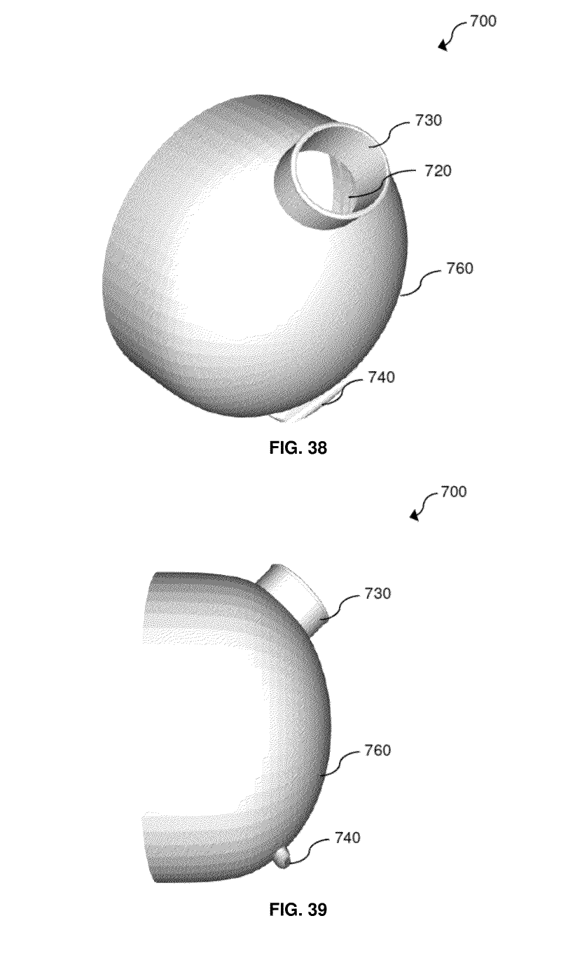

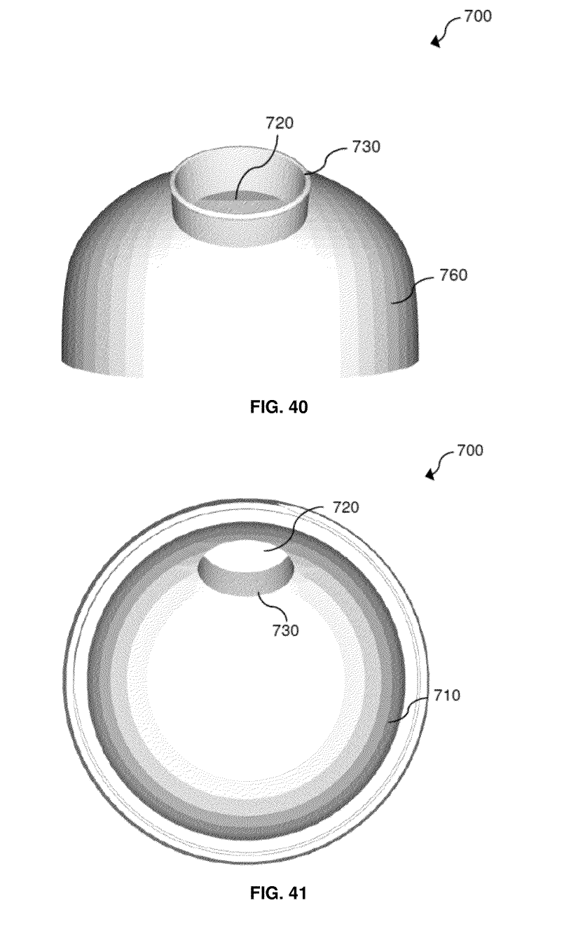

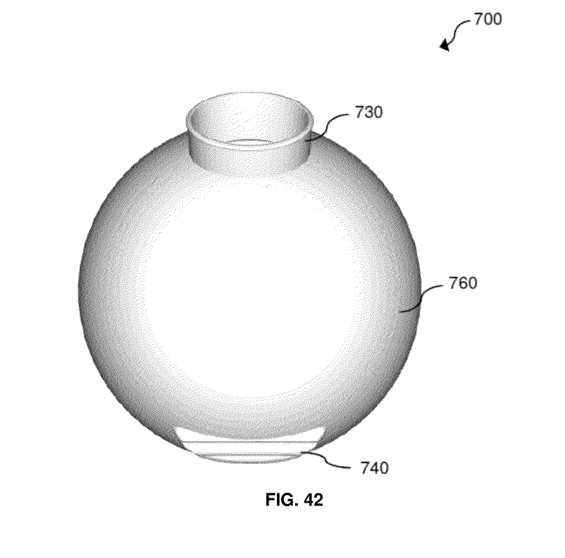

FIG. 35 shows a first perspective view an embodiment of the lid 700 from a system for use with the agitator. FIG. 36 shows a second perspective view of the lid 700 from FIG. 35. FIG. 37 shows a third perspective view of the lid 700 from FIG. 35. FIG. 38 shows a fourth perspective view of the lid 700 from FIG. 35. FIG. 39 shows a side elevational view of the lid 700 from FIG. 35. FIG. 40 shows a front elevational view of the lid 700 from FIG. 35. FIG. 41 shows a bottom plan view of the lid 700 from FIG. 35. FIG. 42 shows a top plan view of the lid 700 from FIG. 35.

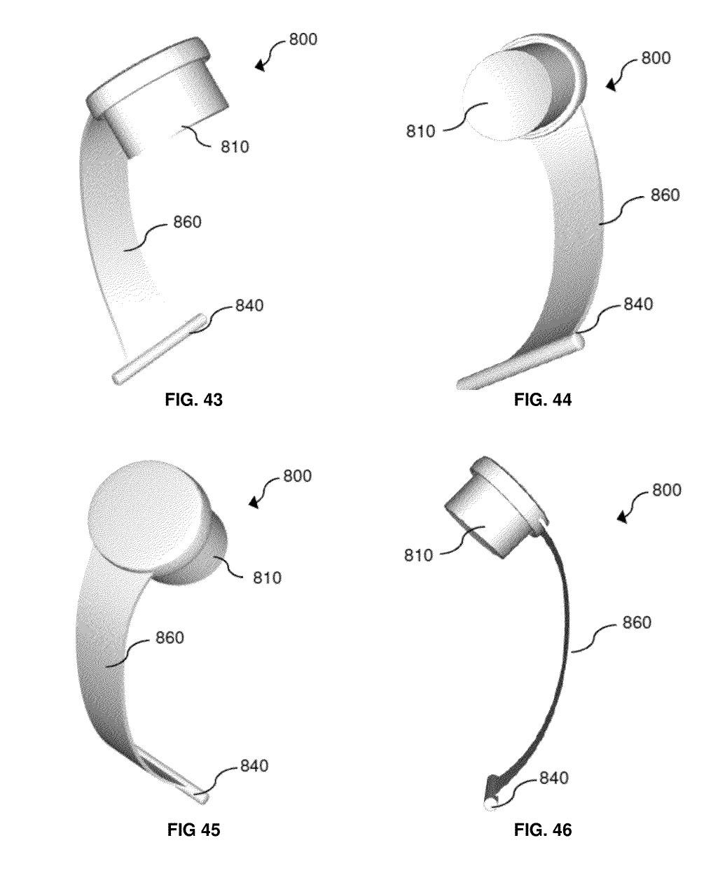

FIG. 43 shows a first perspective view an embodiment of the cap 800 from a system for use with the agitator. FIG. 44 shows a second perspective view of the cap 800 from FIG. 43. FIG. 45 shows a third perspective view of the cap 800 from FIG. 43. FIG. 46 shows a side elevational view of the cap 800 from FIG. 43.

“Liquid medium” includes solvents, such as water. In particular embodiments, the liquid medium is an aqueous medium, such as water, saline, buffered saline, dextrose water, or milk.

The powder may be a nutritional powder, such as a protein powder, fiber powder, or infant formula. The powder may also be a nutrient medium, such as a broth for cellular cultures, or salts for preparing buffered solutions. In other embodiments, the powder is a medicament that is made into a solution, suspension or syrup for oral or parenteral administration.

Also provided herein is a method for mixing a powder into a liquid medium. The method comprising: providing a system comprising an agitator. In some embodiments, the agitator may be any agitator as described herein. For example, the agitator may comprise a body having a central axis and an asymmetric weight distribution, and a plurality of spines, each spine having a shaft and a termination. The system is contacted with the powder and the liquid medium, closed, and shaken, so as to effect mixing between the powder and the liquid medium. The powder may be a protein-containing powder and the liquid medium may be an aqueous medium.

Further provided is a method for making an agitator. The method comprises shaping the agitator, for example by molding or three-dimensional printing.

The use of the word “a” or “an” when used in conjunction with the term “comprising” in the claims or the specification means one or more than one, unless the context dictates otherwise. The term “about” means the stated value plus or minus the margin of error of measurement or plus or minus 10% if no method of measurement is indicated. The use of the term “or” in the claims is used to mean “and/or” unless explicitly indicated to refer to alternatives only or if the alternatives are mutually exclusive. The terms “comprise”, “have”, “include” and “contain” (and their variants) are open-ended linking verbs and allow the addition of other elements when used in a claim.

From the preceding description of various embodiments of the present invention, it is evident that the objects of the invention are attained. Although the invention has been described and illustrated in detail, it is to be clearly understood that the same is intended by way of illustration and example only and is not to be taken by way of limitation. Accordingly, the spirit and scope of the invention are to be limited only by the terms of the appended claims.

What is claimed is:

1. An agitator, comprising:
a body having a central axis and an asymmetric weight distribution; and
a plurality of spines, each spine having a shaft and a termination, wherein the shaft smoothly transitions from the body;
wherein the body and spines are adapted to enhance mixing when the agitator is shaken in a vessel containing a powder and a liquid medium.

2. The agitator of claim 1, wherein the body is egg-shaped.

3. The agitator of claim 1, wherein the plurality of spines comprises 8 to 21 spines.

4. The agitator of claim 1, wherein the plurality of spines are radially distributed about the central axis.

5. The agitator of claim 4, wherein the radially distributed spines are grouped into sets.

6. The agitator of claim 5, wherein each set is offset by about 10° to about 45° from the neighboring set down the central axis.

7. The agitator of claim 5, wherein the plurality of spines comprises at least three sets.

8. The agitator of claim 2, wherein the plurality of spines comprises one spine located at the apex of the narrow part of the egg-shaped body aligned with the central axis, and four sets of four spines, each set being radially distributed about the central axis in the shape of a square.

9. The agitator of claim 1, wherein each spine termination is a knob that is proportionally wider than the shaft of the spine.

10. The agitator of claim 1, wherein the body is cylindrical.

11. The agitator of claim 10, wherein the cylindrical body further comprises a top knob at a first end of the body and a bottom knob at a second end of the body, wherein the top knob is larger in circumference than the bottom knob.

12. The agitator of claim 10, wherein the plurality of spines comprises 9 to 12 spines.

13. The agitator of claim 10, wherein the plurality of spines are radially distributed about the central axis.

14. The agitator of claim 13, wherein the radially distributed spines are grouped into sets.

15. The agitator of claim 14, wherein each set is offset by about 10° to about 45° from a neighboring set down the central axis.

16. The agitator of claim 14, wherein the plurality of spines comprises at least three sets.

17. A system comprising:
a vessel having an first inner surface;
a lid having an second inner surface that communicates with the first inner surface to form an inner cavity which is substantially free of any hard corner or crevice.

18. The system of claim 17, wherein the lid further comprises an opening, and
wherein the system further comprises a cap having a plug and a fastener,
the plug adapted with a third inner surface that communicates with the second inner surface so as to be substantially free of any hard corner or crevice when the plug is inserted into the opening of the lid, and
the fastener adapted to secure to an outer surface of the lid.

19. The system of claim 18, further comprising an agitator, comprising:
a body having a central axis and an asymmetric weight distribution; and
a plurality of spines, each spine having a shaft and a termination, wherein the shaft smoothly transitions from the body;
wherein the body and spines are adapted to enhance mixing when the agitator is shaken in a vessel containing a powder and a liquid medium.

20. An agitator, comprising:
a body having an asymmetric weight distribution; and
a plurality of spines, each spine having a shaft and a termination, wherein the terminations form a locus of points describing a sphere.
